(19) United States
(12) Patent Application Publication
(10) Pub. No.: US 2016/0275723 A1
(43) Pub. Date: Sep. 22, 2016

(54) SYSTEM AND METHOD FOR GENERATING THREE DIMENSIONAL REPRESENTATION USING CONTEXTUAL INFORMATION

(71) Applicant: Deepkaran Singh, Anaheim, CA (US)

(72) Inventor: Deepkaran Singh, Anaheim, CA (US)

(21) Appl. No.: 15/052,632

(22) Filed: Feb. 24, 2016

Related U.S. Application Data
(60) Provisional application No. 62/136,429, filed on Mar. 20, 2015.

(51) Int. Cl. G06T 19/00; G06F 3/0484; G06T 17/00; G06T 19/20

(52) U.S. Cl. CPC G06T 19/006; G06T 19/20; G06F 3/04845; G06T 17/00

(57) ABSTRACT

The present invention relates to a system and a method for generating 3D representation using contextual information. The method may include determining presence of 3D model and at least one AR scene corresponding to at least one object. The object may be inputted by a user or may be determined and scanned by the method. The 3D model(s), AR scene may be retrieved based on the object. Alternatively, the 3D model, AR scene and corresponding contextual objects may be generated through the object's image. Further, the user may be facilitated to add at least one of the 3D models (retrieved or converted 3D models), or contextual objects in an existing AR scene or may create a new AR scene. The AR scene, 3D model and contextual objects may further be customized. At least one of the generated 3D models, contextual objects and AR scenes may then be displayed online to facilitate users (consumers) to sale/purchase via a commerce module.

### FIELD OF THE INVENTION

The present invention relates generally to the field of image processing and more particularly, the present invention relates to a system and a method for generating three dimensional representation by using contextual information.

### BACKGROUND

Current scenario of technology advancement includes an increasing interest in visual media that has become an integral part of most of the industries such as entertainment, real estate, information exchange and so on. Further, in e-commerce, a better visualization of the required item is prior concern of any consumer. Typically, video or picture data can be viewed on a screen as a two dimensional image. Also, the two dimensional image data can be converted into three-dimensional image by utilizing existing techniques using multiple cameras and sensors.

Conventionally, the process of converting two-dimensional (2D) images to three-dimensional (3D) object(s) involves extraction of depth information of an object/image. For this, high resolution cameras are used to capture images and then adjustment of images is performed in depth map to convert 2D images to 3D objects/models.

Further, one of the known techniques include Structure from Motion (SFM) approach, depth differences between moving pixels and still pixels is determined by tracking pixels in consecutive frames of video data. Further, a depth map or map of relative depths of pixels in an image (2D) is determined using geometry fitting of the determined motion structure. The SFM approach is highly complex and requires large amount of time for its processing. Therefore, the SFM approach is less reliable where the 3D output is required immediately or the conversion from 2D images to 3D objects/models is required in real time.

Generally, existing techniques involve usage of expensive cameras and require heavy time consumption in arranging cameras at fixed points and positioning of images in depth map along z axis. Additionally, the existing techniques of converting 2D images to 3D objects include capturing 2D images at one time and converting those images into 3D models/objects at other time using expensive and time consuming methods. However, such existing methods do not consider the situation wherein a user may wish to modify the initially captured 2D images or wish to replace the original image with another new image or object any time during the conversion process (2D to 3D conversion). As for such situations, the existing methods may need to repeat the whole process of conversion from 2D images to 3D objects/model including re-arrangement of cameras based on the newly selected image or object by the user. This consumes a significant time and effort of the user in converting a desired 2D image into 3D model.

Additionally, the existing techniques demands selection of all the 2D images as an input by a user for a particular type of video/3D representation to be created for the user. However, many times, the user (consumer) is not fully aware of the type of selections to be made for a desired video/3D representation due to lack of knowledge of the user. To get a particular 3D experience, the user may need to spend a considerable amount of time in understanding his/her needs that is required to be fed as an input for getting the desired result (such as 3D output).

Thus, based on the aforementioned, there is a need of a system and a corresponding method to overcome the drawbacks of existing conventional techniques for generating 3D models and to provide additional features for intelligent generation of 3D representations on the fly and in easy and convenient way. Further, the system should be able to facilitate a user to modify images anytime during the process of generation of 3D representation for better user experience. Furthermore, such system should be able to provide a better 3D experience to a user without forcing the user to take part in complex and expensive process of arranging multiple cameras and sensors for capturing the images of an object from various angles. Additionally, the system should facilitate a user to convert one or more images in real time (on the fly) without requiring any involvement in arduous activities and expensive ways. Moreover, the system should be able to understand the needs of the user and accordingly, the system should be able to provide an aid to the user in getting the desired 3D output.

### SUMMARY OF THE INVENTION

The present invention is directed to providing a system and a method for generating three dimensional representations using contextual information.

According to one aspect of the present invention, a system for generating three dimensional representation using contextual information is disclosed. The system may include a receiver to receive, from a user, one or more inputs such as scanned 2D images of an input object (for example, a chair). Further, the system may include a contextual module for providing augmented reality scene (AR Scene) corresponding to the scanned images along with contextual information (such as contextual objects) to the user. Herein, the contextual objects may include, but are not limited to, 3D models of the related objects. For example, contextual objects for scanned 2D image of a chair may include 3D models of ‘table’ that may be suitable with the chair. In an embodiment the AR scene may be an informative AR scene corresponding to the captured 2D images. Herein, the user may be facilitated to alter the 3D model and/or contextual objects based on his/her preferences. The system may enable the user for generating a video stream or 2D pictures corresponding to the input object. This generated video stream or 2D pictures may be utilized further by the conversion module to convert into 3D models. Further, the conversion module may facilitate the user to decide whether to select an existing AR scene or to create a new AR scene for adding the generated 3D models. Accordingly, based on the user's decision, the conversion module may create a new AR scene through the 3D models or may embed the 3D models in the existing AR scene that may be selected by the user. Herein, the user may further be facilitated to print the 3D model and 3D AR scene either locally or through a remote printing server. The generated 3D models and AR scenes may then be provided to a commerce module of the system that may display the 3D models and/or AR scenes and/or 3D printed object online to facilitate the user to sale/purchase via a commerce module. In an embodiment, the displayed printed objects may facilitate the user to make purchase thereof via a commerce module.

According to another aspect of the present invention, a method for generating three dimensional representation by using contextual information is disclosed. The method may include, but is not limited to, scanning (or facilitating a user to scan) 2D images of an input object. The method may further include creating (or retrieving from a database) an AR scene based on the captured 2D images. Such AR scene may be an informative AR scene that may provide information corresponding to the scanned input object. Further, the method may include providing contextual information/objects corresponding to the scanned object. In an embodiment, such contextual objects may include 3D model that may be related to the scanned object. The user may be facilitated to customize such contextual information corresponding to the object. Furthermore, the method may include facilitating a user to generate video stream or capture pictures of the input object. Additionally, the method may include converting the generated video stream or the captured pictures into 3D models and accordingly a new AR scene may be created. Moreover, the method may include facilitating the user to embed the 3D model into an existing AR scene. Also, the user may be facilitated to add the contextual objects into the new AR scene or an existing AR scene. Again further, the method may include displaying the 3D models, contextual objects and/or AR scenes online to enable sale/purchase via a commerce module.

Further, in accordance with another embodiment of the invention, a computer implemented method for generating three-dimensional representation is disclosed. The method may include, but is not limited to, creating an Informative Augmented Reality scene based on at least one object. The Informative Augmented Reality scene may include, but is not limited to, three-dimensional model corresponding to the at least one object; and contextual information corresponding to one or more contextual objects related to the at least one object. Further, the method may include facilitating the user to customize at least one of: the three-dimensional model, and information corresponding to the contextual objects corresponding to the Informative Augmented Reality scene. The method may further include upgrading the Informative Augmented Reality scene based on the customization of at least one of: the three-dimensional model and the contextual information.

Herein above, the informative Augmented Reality scene is created by performing one of: adding an existing three-dimensional model and the one or more contextual objects corresponding thereto, to an existing Augmented Reality scene; and generating a three-dimensional model corresponding to the at least one object to generate an Augmented Reality scene therefrom. Herein, the one or more contextual objects are added to the generated Augmented Reality scene to create the Informative Augmented Reality scene. The three-dimensional model is created by performing at least one of: facilitating the user to generate one of: a video stream and two-dimensional pictures based on the at least one object; performing one of: image extraction and image correction from the generated video stream and the two-dimensional pictures respectively; and performing two-dimensional to three-dimensional stitching to generate the three-dimensional model.

In accordance with yet another embodiment of the invention, a computer implemented method for generating three-dimensional representation is disclosed. The method may include, but is not limited to, determining presence of at least one of three-dimensional model and at least one Augmented Reality scene corresponding to at least one object; providing at least one of: three-dimensional model and Augmented reality scene with corresponding one or more contextual objects to a user, when the presence of at least one of three-dimensional model and at least one Augmented Reality scene is determined; facilitating the user to perform customization of at least one of: the three-dimensional model, and the contextual objects. Further, the method may include performing at least one of one or more functionalities to generate an upgraded Augmented Reality scene based on the customization.

Further, in accordance with another embodiment of invention, a system for generating three dimensional representation is disclosed. The system comprising a processor and a memory having instructions, wherein the instructions executable by the processor to: create an Informative Augmented Reality scene based on at least one object. The Informative Augmented Reality scene comprising: three-dimensional model corresponding to the at least one object; and contextual information corresponding to one or more contextual objects related to the at least one object. Further, the instructions executable by the processor to facilitate the user to customize at least one of: the three-dimensional model, and information corresponding to the contextual objects corresponding to the Informative Augmented Reality scene; and upgrade the Informative Augmented Reality scene based on the customization of at least one of: the three-dimensional model and the contextual information.

Hereinabove, the instructions executable by the processor creates the Informative Augmented Reality scene by performing one of: adding an existing three-dimensional model and the one or more contextual objects corresponding thereto, to an existing Augmented Reality scene; and generating a three-dimensional model corresponding to the at least one object to generate an Augmented Reality scene therefrom. Herein, the one or more contextual objects are added to the generated Augmented Reality scene to create the Informative Augmented Reality scene. Further, the instructions, executable by the processor, create the three-dimensional model by performing at least one of: facilitating the user to generate one of: a video stream and two-dimensional pictures based on the at least one object; performing one of: image extraction and image correction from the generated video stream and the two-dimensional pictures respectively; and performing two-dimensional to three-dimensional stitching to generate the three-dimensional model.

Further, the system may include the instructions, executable by the processor, further configured to facilitate the user to customize at least one of: the existing three-dimensional model and the contextual objects corresponding thereto. Furthermore, the instructions, executable by the processor, further configured to determine presence of at least one of: the existing Augmented Reality scene and the existing three-dimensional model. The instructions, executable by the processor, further configured to determine the one or more contextual objects based on at least one of: the at least one object, the three-dimensional model, the user preferences, user situation and past history.

Again further, the instructions, executable by the processor, are further configured to perform one or more functionalities corresponding to the upgraded Informative Augmented Reality scene. The one or more functionalities may include, but are not limited to, outputting the upgraded Informative Augmented Reality scene to the user; enabling commercialization of at least one of: the upgraded Informative Augmented Reality scene, three-dimensional model corresponding to the Informative Augmented Reality scene, and contextual objects corresponding to the Informative Augmented Reality scene; and performing 3D printing of at least one of: the three-dimensional model, contextual objects, and Informative Augmented Reality scene.

Again further, the system may include instructions executable by the processor for further determining the at least one object by performing one of: scanning of an object based on at least one of: the user's preferences, the user's situation and the user's input; and receiving the at least one object as input from the user.

### BRIEF DESCRIPTION OF THE DRAWINGS

The present invention will now be described by way of example with reference to the following drawings in which:

FIG. 1 is an exemplary representation of a system for generating three dimensional representation using contextual information, in accordance with one embodiment of the present disclosure;

FIG. 2 is an exemplary environment in which a system may be implemented, in accordance with an embodiment of the present disclosure;

FIG. 3 depicts an exemplary AR scene with contextual information, in accordance with an embodiment of the present disclosure; and

FIGS. 4A and 4B depict a flow diagram illustrating a method for generating three-dimensional representations by using contextual information, in accordance with an embodiment of the present invention.

### DETAILED DESCRIPTION

The present invention provides a system and a method for generating three dimensional representation using contextual information. Herein, the three dimensional representation may be generated from a two dimensional (hereinafter may interchangeably be referred to as ‘2D’) image of an input object that may be provided as input (by the user) to the system. In an embodiment, the user may scan the input object or capture a 2D image of the object by utilizing one or more devices such as phone, tablet, eyewear or a special device. The input object may be captured from a camera of a device such as, but is not limited to, a mobile device. Further, in another embodiment, the user may select the 2D image from an external source such as through internet.

Further, in an embodiment, if the user scans the input object in a store then the system may provide object information of the scanned object that is available in that particular store. In an embodiment, the system may provide an augmented reality (AR) scene for placing such scanned object therein to enable the use to visualize such scanned object in that AR scene. In an embodiment, the AR scene provided to the user (consumer) may be an informative AR scene that may include information corresponding to the scanned object. In an exemplary embodiment, the system may provide various 3D models corresponding to various similar objects (similar to the scanned objects) available at the store. Additionally, the system of the present invention may provide contextual information (such as contextual objects) that may be related to the scanned objects. In one embodiment, the contextual information (3D objects) may be determined based on a user's requirements. Herein, according to one embodiment, the user's requirements may be determined through the two dimensional image (scanned object) provided by the user. For example, if a user wishes to convert a 2D image of a house (initial input) into three dimensional (hereinafter may interchangeably be referred to as ‘3D’) model for a real estate project, the system may provide contextual information related to the household items such as furniture, electric items, and the like. In an embodiment, contextual information may be provided as one or more scenes to the user to enable the user to select one or more items from such contextual scenes. The one or more items selected from the contextual scenes may further be customizable by the user. The user may utilize one of the selected one or more contextual scenes and the customized contextual scenes to create a new Augmented Reality (AR) scene. Further, the user may utilize the customized contextual scenes for any existing AR scene as well.

Further, in an embodiment, an Augmented Reality (AR) scene may be developed that may include real world environment to describe the object (as provided through the input image). Such AR scene may enable the user to visualize the object and its placement in the real world environment. In an embodiment, the AR scene may include an environment based on the user's situation and preference. In an embodiment, the situation and preference of the user may be determined by the system. For example, if the user input a 2D image of a house for a real estate project then an augmented reality scene may include a view of the house in an environment that may, for example, be related to the actual place where the house is constructed or will be constructed along with surrounding environment of such place.

Further, the environment of AR scene may be created based on the user's situation and preferences. In one embodiment, the user may be able to provide the user's situation and preferences as an input to the system. In another embodiment, the user's situation and preferences may be determined based on past activities of the user. In this embodiment, the user may be registered with the system and the user's activities may be tracked by the system. For example, the user wishes to provide a play ground inside the house then the AR scene may be developed accordingly to depict the play ground inside the house. Herein, the system may not be restricted to the play ground, the AR scene may further include one or more objects of the real world environment so as to enable the user to visualize the scene.

Further, for example, if a user wishes to decorate his/her living room and, for the same reason, the user visits a store to buy a chair. In an embodiment, the user may be facilitated to create an AR scene for his/her living room. In an embodiment, the AR scene may be generated by clicking the picture from a device and converting such clicked pictures (2D pictures) to 3D representation. Further, the AR scene of the living room may be created by the user to view whether the chair that the user wants to buy will be suitable in the living room or not. For this, the user may visit a store to select a chair. The chair (at the store) may be scanned by the user to receive information corresponding thereto. Such information may be displayed in an AR scene (say AR scene ‘X’) on the display screen of a device from which the object (i.e., chair in this example) is scanned. Further, the AR scene is not limited to a description AR scene, it may include a visual representation of an existing view wherein the selected chair may be displayed to the user to depict suitability of the selected chair in a particular environment (for example, living room).

In an embodiment, the contextual information may further be provided to the user that may include 3D models of objects related to chair. For example, the contextual information may include one or more objects those are related to the initial object scanned by the user. Additionally, one or more 3D models of the other similar objects may also be displayed to the user. For example, if the user scans a backless chair, the 3D model of another chair with back can be displayed to the user. It may be appreciated by a skilled in the art that the 3D model of the similar items may be displayed those are available at the store at the time of purchasing being made by the user. Due to this, the user may be provided with the choices available to him/her at the time of purchasing. Further, in an embodiment, the descriptive AR scene may provide cost corresponding to the 3D model that may be displayed on selecting a particular 3D model from the available number of 3D models.

The user may select at least one of the 3D models of the similar objects and 3D models of the contextual objects to fit in the AR scene (such as the AR scene ‘X’) corresponding to the living room created by the user.

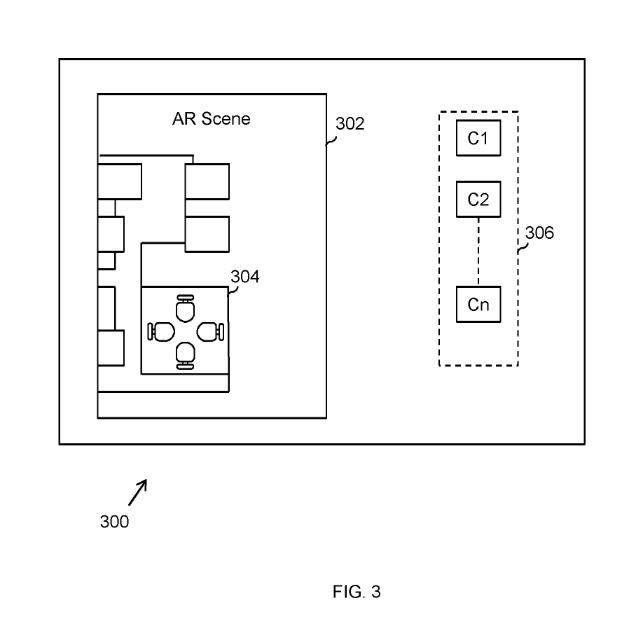

For example, if the selected contextual item is household electric item, such as ‘Air Conditioner’ (‘AC’), then the AR scene may depict one or more ACs fixed to the house window(s). In this embodiment, the system may provide contextual models inside the AR scene. Further, in another embodiment, the system may provide information corresponding to one or more contextual objects in a descriptive AR scene. Further, the system may depict one or more options for enabling the user to select one or more contextual items (objects) corresponding to the user's initial input. For example, the options corresponding to the contextual items such as parking area, play rides for the play ground of the house, electric items and so on. The user may be enabled to select one or more contextual items by dragging the desired contextual items from a list of options (corresponding to contextual objects) provided by the system. The dragged items may be dropped inside the created AR scene. Such scene may be displayed to the user. The user may further be facilitated to modify the AR scene by adding new items or by discarding existing items from the created AR scene. This is further explained in conjunction with FIG. 3.

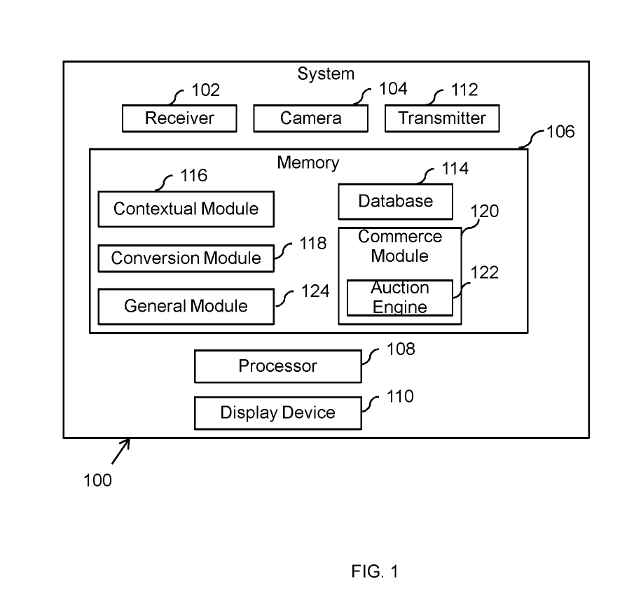

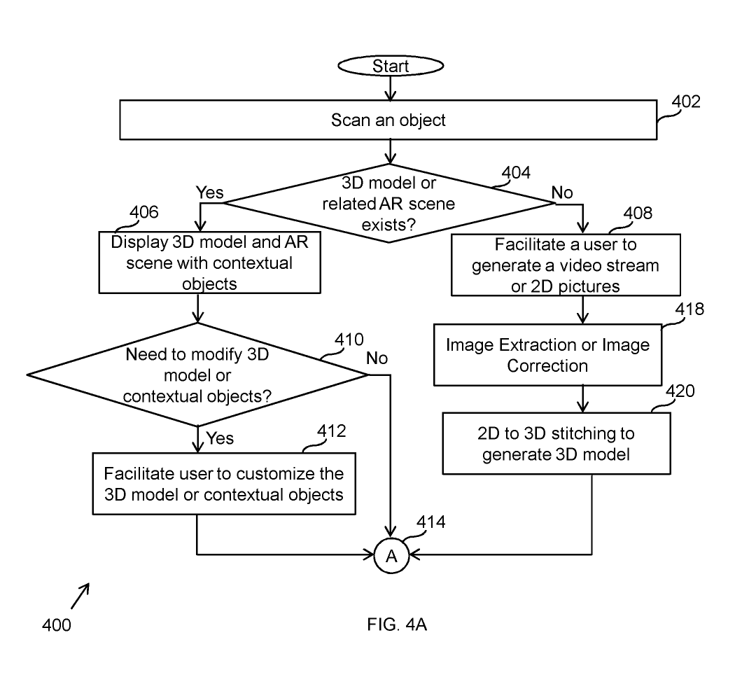

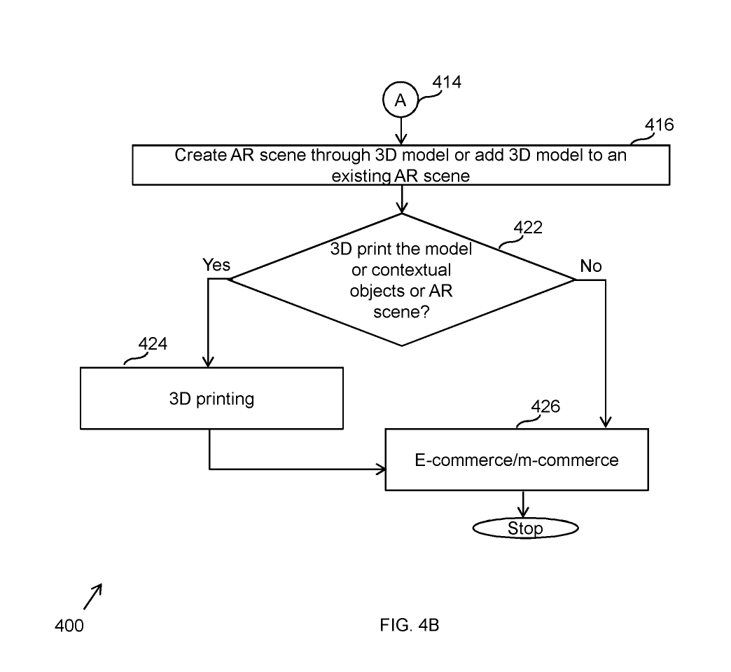

In an embodiment, the scanned object may be captured to generate a video stream or 2D images. Such 2D images or video stream may be converted into 3D representation by 2D to 3D stitching to create 3D models. The user may be facilitated to create a new AR scene by using such 3D models. Further, in an embodiment the user may embed such 3D models in an existing AR scene, for example, the AR scene X of the living room (as described previously in this disclosure). At every step of the process, the system may facilitate the user to modify the 3D model (automatically generated by the system or created by the user), contextual objects and AR scenes according to his/her own choice. Thus, the system provides a user friendly environment wherein the user is provided with multiple choices based on the user's situation and preference. The system is explained further in detail in conjunction with FIG. 1. The user may 3D print the model, AR scene or the contextual objects. Further, the user may commercialize the customized 3D model, AR scenes or contextual objects through a commerce module of the system, as described further in conjunction with FIGS. 1, 2, and 4 (i.e., FIGS. 4A and 4B).

Referring now to FIG. 1, FIG. 1 represents an exemplary representation of a system 100 for generating three dimensional representations by using contextual information, in accordance with one embodiment of the present invention. In an embodiment, the system 100 may be implemented in a mobile device. The system 100 may include, but is not limited to, a receiver 102, a camera 104, a memory 106, a processor 108, a display device 110 and a transmitter 112. In an embodiment, a user may be registered with the system 100. The receiver 102 may be utilized to receive input from a user. In an embodiment, the input received by the receiver 102 may include, but is not limited to, the user's preferences and situation. Further, the user may input one or more 2D images as input for converting into 3D representation(s). It may be appreciated by a person skilled in the art that the system 100 is not restricted to the input received by the receiver 102. In an embodiment, the system 100 may analyze the user's past activities to know about the user's preferences and interest.

Further, the system 100 may receive input through the camera 104. The user may utilize the camera 104 to capture one or more objects. In an embodiment, the user may activate camera 104 by pressing a button to capture one or more images (2D) of an object from various angle. Further, in an embodiment, the object may be lying on a surface and the user may be required to activate the camera 104 through a control (such as a camera button). In this, the user may need to rotate the camera 104 around the object to capture one or more images of the object by keep on pressing the camera 104 control. Further, on releasing the camera control (such as the camera button), the 2D images may be captured from various angles for conversion of such images from 2D to 3D. Alternatively, the object may be held by the user with hands or a special device. Further, in this case, the object may be rotated without moving the camera (such as a camera of a cell phone), an eyewear or a special device that is being used by the user for capturing the object. In an embodiment, such captured images may directly be transferred to a cloud (or to a server) through an Internet for conversion thereof from 2D to 3D. In this embodiment, the images may be transmitted to the cloud through the transmitter 112. In an alternative embodiment, the images may be converted from 2D to 3D by the system 100 without transmission thereof to the cloud.

Further, in another embodiment, the initial input object may be scanned through various devices, such as through mobile phone's camera (such as the camera 104) or scanner, Tablet, eye wear and so on, from various angles to capture 2D images of the object. It may be appreciated by a person skilled in the art that the object scanning may not be limited to the aforementioned discussion. Further various other devices may be utilized for scanning/capturing the object through various ways.

The captured 2D images/scanned images of the initial input object may be processed through a processor 108 by executing one or more instructions stored in the memory 106. In an embodiment, the memory 106 may store instructions that may be executed by the processor 108 to perform one or more tasks. Further, the memory 106 may include one or more modules wherein each module may include one or more instructions that may be executed by a processor (such as the processor 108) to carry out the functionality of each module. As depicted, the memory may include, but is not limited to, a database 114, a contextual module 116, a conversion module 118, and a commerce module 120. The commerce module 120 may include an auction engine 122. Further, the memory may include one or more instructions corresponding to a general module 124 to perform one or more tasks to implement the system. It may be apparent to a person skilled in the art that the processor 108 may execute instructions corresponding to each module stored in the memory 106 to perform the functionalities corresponding to the module.

In an embodiment, the database 114 may include information corresponding to each user of the system 100. In an embodiment, the user may be registered with the system 100. The database 114 may include, but is not limited to, the information corresponding to the user of the system 100. For example, the database 114 may include, but is not limited to, the profile information of the user, preferences of the user, activities of the user, input received from the user and other information corresponding to the user may be stored in the database. Further, the contextual module 116 may determine contextual information (objects) corresponding to the input object captured/scanned/inputted by the user. The contextual information may be determined by analyzing the shape of the object captured/inputted by the user. Based on analysis of shape of the object, the contextual module 116 may recognize the object and accordingly may provide the contextual information based on the recognized object.

Further, it may be appreciated by a person skilled in the art that the contextual module 116 may have learning capability for remembering the recognized shapes and the context information provided for such recognized shapes. Such recognized shapes and context information may be stored in a database, such as the database 114, and may be utilized by the context module 116 in future. For example, the contextual module 116 may recognize the image of the object by analyzing the shape thereof and based on the analysis, the contextual module 116 may determine that such shape has already been used by the same user or another user in the past. Accordingly, the contextual module 116 may retrieve the corresponding contextual information that was suggested in the past. For example, the contextual module 116 may directly retrieve the 3D model(s) corresponding to the recognized shape from the past record. Such retrieved models may be provided as suggestions to the user. The user may thereby be facilitated to select one or more of the suggested 3D models for 2D images. In an embodiment, the contextual module 116 may further facilitate the user to customize such 3D models. Further, the user may be facilitated to utilize such customized 3D models to create a new AR scene or by adding in an existing AR scene.

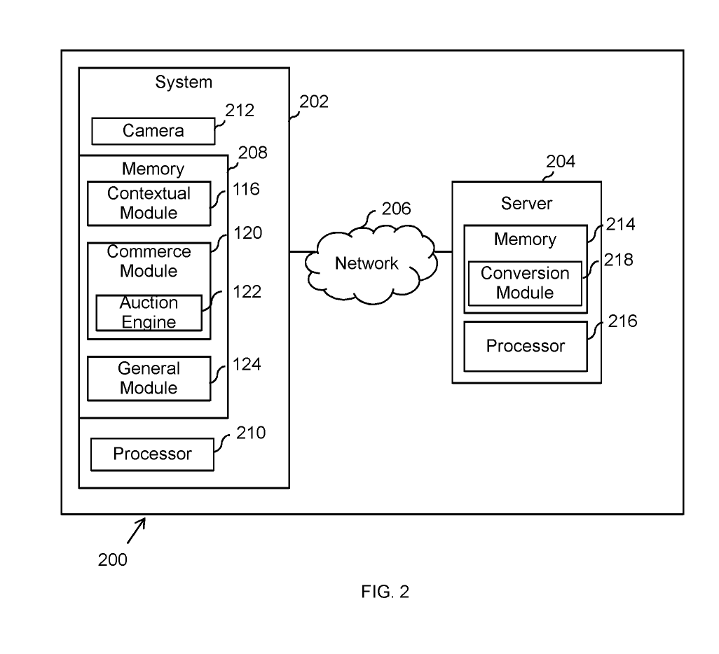

For example, if a user selects/scans an initial input object then the general module 124 of the system 100 may determine whether a 3D model or an AR scene or one or more contextual objects related to the initial input object exists in the database 114. In an embodiment, the system may determine the existence of such 3D model, AR scene or contextual objects by scanning through a memory of a cloud server (as depicted in FIG. 2). In an embodiment, the 3D model may be of objects similar to the scanned input image. For example, if the scanned input image is of a ‘chair’ then the 3D model may correspond to models of other similar objects that may be available for the purchase of the user. Herein, it may be appreciated by a person skilled in the art that if the user scans an object such as the ‘chair’ in a store then the 3D models may belong to other chairs (other than the scanned chair) available in that store to facilitate the user to make decision corresponding to selecting a type of chair from the available chairs in that particular store.

Further, the AR scene may include an informative AR scene that may provide descriptive information corresponding to the scanned object. The user may understand the cost, features etc., associated with the scanned object through such AR scene. In an embodiment, the AR scene may depict an exemplary environment/scenes wherein the chair may be placed and depicted to the user. Furthermore, the contextual information may include information corresponding to the related object such as ‘table’. Thus, the contextual information may be provided corresponding to various types of ‘tables’ available at the store. If the system finds at least one of related 3D model or existing AR scene or contextual information then the system may display such found information to the user. The user may utilize such 3D models for creating AR scenes or for embedding such 3D models in an existing AR scene. Additionally, the user may be facilitated to customize at least one of the tables that the user may select from the contextual objects.

In an embodiment, the contextual module 116 may analyze the shape of the selected image and may determine that the image represents a ‘chair’. Accordingly, the contextual module 116 may determine that the contextual object corresponding to the object ‘chair’ may include ‘table’. In one embodiment, the contextual module 116 may display (through the display device 110) one or more corresponding 3D models (from past stored record of the same user or another user). Such 3D models may directly be utilized by the user based on his/her requirement. In another embodiment, the contextual module 116 may provide an option of including the recognized contextual object such as ‘table’ in the corresponding AR scene.

Further, in an example, for decoration of a living room of the user, the user may input a 2D image of marble flooring to convert into 3D representation to determine how such flooring may look like. In an embodiment, the system may develop an AR scene (say AR scene ‘X’) of the living room wherein the user wants such flooring to provide visual representation of 2D image of such flooring in an environment to provide a visualization of such flooring in the living room of the user. For this, the user may click the picture of the living room that may be stitched into 3D for creating an AR scene of the living room. In an embodiment, the user may provide further information to the system 100 regarding the spacing in/size of the living room. The system 100 may develop the AR scene according to the user's input. Further, the user may scan image of such desired flooring and accordingly the contextual module 116 of the system 100 may provide contextual information to the user that may be related to the object selected/captured by the user. For example, the contextual module 116 may provide one or more options corresponding to ‘granite’ flooring to be suitable with the interior of the living room of the user. Such contextual options related to the context of the inputted image may be provided to the user to enable the user to select at least one option therefrom.

In an embodiment, such contextual options may be provided along with the developed AR scene. The user may be enabled to select a required design of granite flooring from the available options and drag the selected option into the AR scene. The dragged option (i.e., the image of the selected table) may be placed suitably inside the AR scene. In an embodiment, the user may select and/or deselect one or more items from AR scene to depict his/her selection of objects (from the AR scene) for converting into the desired 3D representation. Further, in an embodiment, the user may be facilitated to select one or more objects from external sources such as external folders (in a mobile device or personal computer or through a device implementing the system 100) or through internet. Such selected objects may be embedded in AR scene to provide 2D visual representation (image) of the selected/captured objects.

In another embodiment, the contextual module 116 of the system 100 may provide an informative AR scene that may provide the description of the scanned object such as marble flooring. For example, the descriptive AR scene may depict price, size required for a particular size of the living room, color etc. Additionally, the contextual module 116 may provide 3D models those are already available in the memory corresponding to the required scanned object. For example, if the 3D model depicts a model of a particular type of marble flooring that is available at the store while doing purchasing or enquiring about the marble flooring.

The developed AR scene, 3D model and the contextual objects may be customizable by the user. Such customization may enable the user to create his/her own AR scene. Further, the user may utilize such customized 3D models or contextual objects in an existing AR scene, for example the customized 3D models or customized contextual objects may be embed in the already developed AR scene of the living room.

In one embodiment, if the 3D model, AR scene or contextual objects are not available in the system's memory (or on cloud) corresponding to the scanned object (such as marble flooring or chair) for a living room of the user then the user may capture the object (such as a chair or marble flooring) from a store or from other place from where the user is viewing the object. In an embodiment, the system 100 may automatically generate a video stream or collect images (2D). Further, in another embodiment, the user may be enabled to select/capture images from his/her image database externally or through internet. Based on these embodiments (but not restricted to), the user may choose the desired collection of images or may be facilitated to generate a video stream that may be provided as an input to the conversion module 118 for converting such images/video stream into a 3D representation.

In an embodiment, the conversion module 118 may be implemented in a device implementing the system 100. In another embodiment, the conversion module 118 may be implemented on a server to convert the 2D images/video stream into a 3D representation. If the input to the conversion module 118 is the video stream then the conversion module 118 may extract one or more images from the video stream. Further, if the input to the conversion module 118 includes one or more images (or a group of images) then the conversion module 118 may perform image correction on the received images. Further, in an embodiment, the conversion module 118 may determine raw images from the group of images and filter automatically the refined images from the group of images for 2D to 3D stitching of the filtered images to generate 3D models.

Thus, the images for 2D to 3D stitching may include, but are not limited to, the images extracted from video stream, the corrected images and the filtered images that may be converted into 3D model. Further, in an embodiment, the 2D to 3D stitching may be performed in real time to generate 3D models. In an embodiment, the system 100 may facilitate the user to capture images that may directly be converted into 3D models by utilizing 2D to 3D stitching process in real time. In this embodiment, the contextual information may be analyzed by the conversion module 118 at the time of 2D to 3D stitching and accordingly the contextual objects may be embedded in the 3D models based on the user's preferences. Herein, in one embodiment, the user's preferences may be determined by the system 100 through previous history of the user. Further, in another embodiment, the user's preferences may be provided directly by the user. In an embodiment, the conversion module 118 may create an AR scene based on the generated 3D models. Further, the generated 3D models may be embedded inside the already existing AR scenes. For example, the 3D models may be embedded in the AR scene ‘X’ of the user's living room that was developed previously.

The conversion module 118 may further customize the generated 3D models based on the user's requirement. For example, if the user is willing to develop 3D model for his/her living room by adjusting furniture therein then the 3D model may be customized based on the size of the living room and quantity or size of the furniture to be adjusted in the living room. The conversion module 118 may further create an augmented reality scene using such customized 3D models that may be displayed to the user through a display device 110, such as a display screen of a mobile device.

In one embodiment, the user may print at least one of the generated 3D models, AR scenes and contextual objects for further usage thereof. Further, in an embodiment, the printing of the generated 3D models, contextual objects, and AR scenes may be performed remotely through a remote server. In this, the generated 3D models or AR scenes or contextual objects may be transmitted to a remote printer for printing thereof. In another embodiment, the 3D models and 3D scenes may be printed in bulk by a manufacturer or may be commercialized through the commerce module 120 of the system 100.

Further, the conversion module 118 may provide an output to the commerce module 120. The commerce module 120 may include an e-commerce and m-commerce that may be utilized based on the implementation of the system 100. For example, the generated 3D models may be commercialized through Internet using e-commerce and through a mobile device using m-commerce. The commerce module 118 may commercialize the 3D models, 3D contextual objects and 3D AR scenes online for enabling purchase thereof. In an embodiment, the auction engine 122 corresponding to the commerce module 120 may enable selling/purchasing of the generated 3D models, contextual objects and AR scenes based on the highest bidding. Thus, the auction engine 122 may analyze the highest bid for the auctioned model or scene (such generated 3D models or 3D AR scenes) and allows sale to the highest bidder.

It may be appreciated by a person skilled in the art that the system 100 is not limited to the examples and embodiments described herein above. Further, many embodiments and examples may be implemented in light of the present disclosure without departing from the scope of the present disclosure.

FIG. 2 is an exemplary environment 200 in which system may be implemented, in accordance with an embodiment of the present invention. As depicted a system 202 is communicably coupled to a server 204 via a network 206. In an embodiment, the system 202 may be implemented in accordance with system 100 as described and understood in conjunction with FIG. 1. The network 206 may include, but is not limited to, a Local Area Network (LAN) and a Wide Area Network (WAN). In an embodiment, the system 202 may be a standalone computing device such as smartphone, tablet or personal computer (PC). The system 202 may include, but is not limited to, a memory 208, a processor 210 and a camera 212. The memory 208 may include computer readable instructions executable, by the processor 210, to carry out the process corresponding to the system and in accordance with the present disclosure. Further, the memory 208 may further include modules comprising instructions to carry out specific functionality. As depicted, the memory 208 may include, but is not limited to, a contextual module 116, a commerce module 120, and a general module 124. The commerce module 120 may include, but is not limited to, an auction engine 122. The contextual module 116 and commerce module 120 may include instructions executable by the processor 210 to perform functionality as described previously in conjunction with FIG. 1. Furthermore, the camera 212 may be understood in light of the description of the camera 104 as described in conjunction with FIG. 1. As the contextual module 116, the commerce module 120, and the auction engine 122 have already been described in conjunction with FIG. 1, the detail description corresponding to each of these modules is not repeated herein for the sake of brevity.

The server 204 may include, but is not limited to, a memory 214 including one or more instructions and a processor 216 to execute the instructions stored in the memory 214. The memory 214 may include, but is not limited to, a conversion module 218. The conversion module 218 may be utilized to convert 2D images or video stream into 3D model or 3D scene. In an embodiment, the conversion module 218 on the server 204 may be implemented in accordance with the conversion module 218 as described in conjunction with FIG. 1. The server 204 may be remotely located device such as smartphone, personal computer, tablet etc. In an embodiment, the system 202 may store each user's information on the server.

The system 202 may facilitate a user to select a 2D image or scan an input object. The selected 2D image/scanned object may be analyzed by the system 202. Further, the contextual module 116 (of the system 202) may analyze the scanned image and provide a list of contextual objects based on the analysis. More specifically, the contextual module 116 may analyze shape of the scanned image to recognize an object corresponding to the captured image. Accordingly, the contextual module 116 may enable the user to select one or more contextual objects from the list of contextual objects. In an embodiment, the contextual module may further create an AR scene based on the user's 2D image (as inputted by the user). In addition to the AR scene, the list of contextual objects may be displayed to the user for enabling the user to select one or more contextual objects by dragging them into the AR scene. The user may be facilitated to add/delete one or more objects into/from the AR scene respectively.

In an embodiment, the AR scene may just be an informative scene wherein the description of the scanned object may be displayed to the user. Further, in an embodiment, the contextual module 116 may further provide 3D models based on the scanned image. For example, if the scanned image is an image of a ‘chair’ then the 3D models may belong to chairs to depict various designs of chairs available for the purchase. Herein this example, the AR scene may provide the information corresponding to the scanned image for example, the type of the scanned image, colors available, size, cost and so on. Further, the contextual objects in this example may include, but are not limited to, various types of tables that may suit the scanned chair and are available for the purchase by the user. Further, the user may be facilitated to customize such 3D models and contextual objects.

Further, in an embodiment, the system 202 may store the activities of the user corresponding to addition or deletion of the objects into or from the AR scene respectively. Further, the contextual module 116 may track the user's selection of the contextual object from the list of contextual objects provided to the user. Based on this, the contextual module 116 may learn the events corresponding to the user activities and user's preferences. Such learning may be utilized by the contextual module 116 in future by providing contextual information based on user's preferences and activities of the past events. Further, the user may select one or more objects from one or more external sources such as from Internet or locally from a device implementing the system 202. Such selected objects may be added to the AR scene.

Further, the general module 124 may determine if the 3D model and contextual objects are available in the memory 208 corresponding to the scanned image of the user or not. If the 3D model and the contextual objects are not available then the user may capture the input object through a camera, such as the camera 212. Herein, the system is not restricted to capturing through the camera, further various devices those are capable of capturing an object to produce an image or video stream may be utilized for this purpose. Such input object may be captured to generate a video stream or 2D images. The process of capturing is already explained in conjunction with FIG. 1 (though not restricted to such description) and thus not repeated herein for the sake of brevity. The captured video stream or images may be transmitted to the server 204 through a transmitter, such as the transmitter 112.

The server 204 may convert the 2D video stream or images to 3D model or 3D scene. The images may be extracted from the video stream and the captured images may be corrected. Further, the extracted images and/or captured images may undergo 2D to 3D stitching process to generate a 3D model of the captured object. The process of conversion from 2D images to 3D model is previously described in detail in conjunction with FIG. 1 and thus not repeated herein for the sake of brevity. Further, an AR scene may be created from the generated 3D model. The converted 3D model and created AR scene may be transmitted to the system 202 through the network 206 for displaying the 3D model and the AR scene to the user. In an embodiment, the user may utilize the 3D model by embedding such 3D model in the previously existing AR scene. In an embodiment, the user may further modify the 3D model or the AR scene on the fly by altering the objects (3D models) or position of the objects in the scene. Further, the system 202 may enable the user for remote printing of the 3D model or 3D AR scene. In an embodiment, the printer may be connected to the server to enable printing of the 3D model or 3D AR scene.

In an embodiment, the commerce module 120 may be activated to display the generated 3D model, contextual objects and/or 3D scenes online for commercialization. A user (consumer) may view the displayed 3D model, contextual objects and/or the AR scene online and may further be facilitated to purchase the 3D model, contextual objects or the AR scene via e-commerce or m-commerce. Further, in an embodiment, the manufacturer or a business owner may utilize the system 202 for bulk production of 3D models and/or scenes and such 3D models and/or scenes may be displayed online for selling thereof through commerce module 120. Additionally, the commerce module 120 may implement an auction engine, such as the auction engine 122 for enabling users to bid on such 3D models/scenes. The auction engine 122 may analyze the bids and accordingly may facilitate sale to the highest bidder. In an embodiment, the commerce module 120 may be implemented on the server for enabling the user to sell or purchase the 3D models, contextual objects and/or AR scenes.

Referring now to FIG. 3, an exemplary AR scene with contextual information is shown, in accordance with an embodiment of the present disclosure. In an exemplary embodiment, a user may wish to decorate an interior of his/her living room and selects 2D image of a chair. The user may capture the 2D image of the chair from an external source or from a memory of the user's device (such as PC or mobile phone) implementing a system, such as the system 100. In an exemplary embodiment, the system may display an existing AR scene or generate an AR scene based on the captured image. In an embodiment, an existing AR scene may include information corresponding to the captured image. Further, in another embodiment, a generated AR scene, such as the AR scene 302, may depict a house layout wherein rooms may be represented through rectangular blocks along with a passage area between the rooms. The AR scene may depict a living room 304 with four chairs arrangement. Herein, each image of the chair may represent a 3D model of the user's selected image of the chair.

The contextual module 116 of the system 100 or the system 202 may further provide a list of contextual objects. The contextual module 116 may recognize that the image is of a chair by analyzing the shape of the image. Further, the contextual module 116 may determine the contextual information including 3D contextual objects that may correspond to the recognized shape of the image (i.e., ‘chair’) and may relate to the context in which the image is used. As depicted, the list of contextual objects 306 includes contextual object C1, contextual object C2 and up to a contextual object Cn. For example, the contextual objects may include images of ‘tables’ of various designs and shapes that may suit appropriately with the selected image of the chair. Further, for example, if the chair selected by the user is round in shape then the contextual object may include round tables and if the chair selected is a rectangular desk chair then the contextual object may include rectangular table that may suit the selected image of the user.

In an embodiment, the user may select a particular contextual object from the list of contextual objects. The user may further drag the selected contextual object and drop the selected contextual object in the AR scene based on his/her desired arrangement. By this, the user may personalize the AR scene based on his/her own choice and interest. In an embodiment, the user may be facilitated to select a contextual object from an external source and to further embed the selected contextual object into the AR scene. This provides information to the user regarding the possible contextual object corresponding to the selected image of the user's object and further facilitate the user to alter the AR scene by embedding image corresponding to the contextual object of his/her own choice. In an embodiment, the user may be facilitated to customize the contextual object and accordingly to customize the AR scene based on his/her preferences.

In an embodiment, the contextual module 116 may track the user's selection of a contextual object from the list of contextual objects. The tracked information may be stored in the memory of the system that may be utilized by the contextual module 116 in future. Thus, the contextual module is a self learning module that may determine the requirement of the contextual objects based on the user's past activities regarding selection of the contextual objects. Once the AR scene is generated by embedding the contextual information therein, the user may visualize the objects embedded in the AR scene and accordingly may make decision regarding selection/purchase of the objects from a store. The 3D contextual objects and AR scene may be printed remotely via a remote server. Further, the 3D models, contextual objects or AR scenes may be auctioned for sale through a commerce module, such as the commerce module 120. The conversion module 118 and the commerce module 120 are explained previously in conjunction with FIG. 1 and thus not repeated herein for the sake of brevity.

Referring now to FIGS. 4A and 4B illustrating a flow diagram illustrating a method 400 for generating three-dimensional representations by using contextual information, in accordance with an embodiment of the present invention. The embodiments of the method (as depicted in FIGS. 4A and 4B) may be understood more clearly when read in conjunction with description of previous figures, such as FIGS. 1, 2 and 3. The order in which the method is performed is not intended to be construed as limitation, and further any number of the method steps may be combined in order to implement the method or an alternative method without departing from the scope of the present invention.

The method 400 commences at step 402. At step 402, the method 400 may scan an object. Herein, in an embodiment, the object may be an item that a user may want to purchase from a store. For example, the object may be a ‘chair’ that a user may wish to arrange in/decorate a living room of the user. In an embodiment, the user may create an AR scene (say AR scene ‘A’) of the living room by taking pictures of the living room wherein the user wishes to arrange the object such as the chair. Further, the pictures (of the living room) may be converted into 3D representation through 2D to 3D stitching process for creating an AR scene of the living room.

In an exemplary embodiment, the user may visit a store to purchase the object. The user may be facilitated to scan the object to receive information corresponding to the object. Herein, the user may utilize his/her device (implementing the system) to scan the object through the object's bar code.

Further, at step 404, the method 400 may determine whether the 3D model or related AR scene exists in a database (such as the database 114) or memory (such as the memory 214) of a server (such as the server 204). In an exemplary embodiment, the method 400 may determine the position of the user to determine the location of the store where the user is standing for purchasing purpose. Accordingly, the method 400 may interact with the server to extract information (from the memory) corresponding to the scanned item of the store. Further it is determined whether a 3D model or an AR scene related to the scanned object is available or not.

The method 400 may proceed to the step 406 (as depicted through ‘Yes’ pointer from the step 404 to the step 406) if at least one of the 3D model and AR scene (related to the scanned object) is available in the database/memory. Alternatively, the method 400 may proceed to the step 408 if at least one of the 3D model and AR scene (related to the scanned object) is not available (as depicted through ‘No’ pointer from the step 404 to the step 408).

At step 406, the method may retrieve 3D model and AR scene along with corresponding contextual objects from the database or a memory of the server. Such retrieved 3D model, AR scene, and corresponding contextual objects may be displayed to the user. Herein, the 3D model may correspond to the scanned object (i.e., chair). Further, in an embodiment, the AR scene may be an informative scene to provide description of the scanned object. In another embodiment, the AR scene (say AR scene ‘X’) may depict a prospective view of the scanned object in an environment. Further, the contextual objects may be displayed along with the AR scene. The contextual objects may be determined by analyzing the shape of the scanned object. The contextual objects may be selected by the user to add into the AR scene (such as the AR scene ‘X’). The selected one or more contextual objects may be dragged from a list of displayed AR scenes and then dropped into the AR scene (such as AR scene ‘X’) to embed the contextual objects therein. Due to this, the AR scene may be altered based on the user's requirements. The contextual information is described previously in detail in conjunction with FIG. 1, FIG. 2 and FIG. 3 and thus the detailed description thereof is not repeated herein again for the sake of brevity.

Further at step 410, the method 400 may determine if the user wishes to customize the 3D model or the contextual objects. The user may accordingly be facilitated to modify the 3D models or the contextual objects at step 412. From the step 412, the method may proceed to step 416 through a connector 414. Alternatively, if the user does not wish to modify the 3D model or the contextual objects (as may be determined at step 410), the method may directly proceed to step 416 (in FIG. 4B) through a connector 414.

At step 416, the method 400 may create AR scenes through the customized (as customized at step 412) or retrieved (at step 406) 3D models. If the method 400 follows the step 412 then the AR scene may be created at step 416 with the customized 3D models or the customized contextual objects. Alternatively, if the method 400 does not follow the step 412 (on determining that the user does not wish to modify the 3D models/contextual objects), the AR scene may be created at step 416 with the 3D models, as retrieved and displayed at the step 406 without customization thereof. Further, the customized or retrieved 3D models may be embedded into an existing AR scene (for example, the AR scene ‘X’ or the AR scene ‘A’) thereby the existing AR scene may be upgraded based on the customization of at least one of: 3D model and the contextual information corresponding to the contextual objects.

Referring to step 404, if 3D model or AR scene related to the scanned object does not exist in the memory then at step 408, the user may be facilitated to generate a video stream or 2D images of the object. For example, the user may be facilitated to capture the object ‘chair’ to generate a video stream or 2D pictures. For this, in an embodiment, the object may be selected by a user. Further, the method 400 may enable the user to capture one or more images or video stream from external source (i.e., outside the store). The external source may include, but is not limited to, Internet, files and folders corresponding to the user's device that may be utilized for implementing the method 400. The generated video stream and/or 2D images may be provided as an input for conversion thereof into 3D models.

In an embodiment, the 2D images may be captured by activating a control of a capturing device. For example, a camera control may be activated automatically to capture, a selected image, from various angles. Further, in another embodiment, the method 400 may enable the user to capture 2D images of the object through one or more ways. For example, the user may capture the 2D images from various angles through a smartphone's camera, through eyewear, tablet or through a special device for capturing the 2D image. In this embodiment, the user may activate a control, for example, by pressing a button of a camera or through auto focus feature of the camera. In an embodiment, the user may keep on pressing the button to capture the images from various angles and on releasing the button, the scanned 2D images may directly be transmitted to a server to carry out image conversion process on the fly (as described in conjunction with FIG. 2). In another embodiment, the 2D images may be converted into 3D models on the user's device without requiring transmitting the 2D image onto the server for the conversion process (as described in conjunction with FIG. 1).

Further, at step 418, the method 400 may extract images from the 2D video stream or may edit the images/captured pictures for correction thereof. Further, at step 420, 2D to 3D stitching may be performed on the extracted and corrected images to generate 3D models in real time. Further, in an embodiment, the user may be facilitated to further customize such 3D models. Furthermore, at step 416 the method 400 may create an AR scene through the 3D models (generated 3D models or customized 3D models). Alternatively, the 3D models (generated or customized) may be embedded to an existing AR scene (such as an AR scene ‘A’, and the AR scene ‘X”).

Further, at step 422, it is determined whether the user wishes to print the 3D model or contextual objects or AR scene or not. If it is determined that the 3D printing is required then the method may proceed to step 424. Accordingly, 3D models, printed objects, contextual objects and/or AR scenes may be printed remotely through a remote server. After 3D printing, the method may proceed to the step 426 for e-commerce/m-commerce. Alternatively, if 3D printing is not required then the method 400 may proceed directly to step 426 for e-commerce/m-commerce.

Specifically, at step 426, at least one of the 3D model, AR scenes and the contextual objects may be displayed online to enable sale/purchase thereof. Further, the method 400 may include facilitating users to bid for the generated 3D models and/or scenes. Based on the bid amount, the method 400 may automatically select highest bidder and may enable the purchase for that user.

The order in which the method is performed is not intended to be construed as limitation, and further any number of the method steps may be combined in order to implement the method or an alternative method without departing from the scope of the present invention. It may be appreciated by a person skilled in the art that the embodiment of the method of the present invention may not be limited to the description of method FIG. 4 (FIGS. 4A and 4B). Further, various embodiments and steps may be implemented within the scope of the present invention.

The exemplary systems and methods of this present invention have been described in relation to generation of 3D representation using contextual information. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect.

While the invention has been particularly shown and described with reference to a preferred embodiment, it will be understood by those skilled in the art that various changes in form and detail may be made therein without departing from the spirit and scope of the invention. For example, although aspects of the present invention have been described with respect to a computer system executing software that directs the functions of the present invention, it should be understood that the present invention may alternatively be implemented as a program product for use with an image/data processing system. Programs defining the functions of the present invention can be delivered to a image/data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding computer readable instructions that direct the functions of the present invention, represent alternative embodiments of the present invention. While there have been described herein the principles of the invention, it is to be understood by those skilled in the art that this description is made only by way of example and not as a limitation to the scope of the invention.

What is claimed is:

1. A computer implemented method for generating three dimensional representation, the method comprising:
creating an Informative Augmented Reality scene based on at least one object, the Informative Augmented Reality scene comprising:
three-dimensional model corresponding to the at least one object; and
contextual information corresponding to one or more contextual objects related to the at least one object;
facilitating the user to customize at least one of: the three-dimensional model, and information corresponding to the contextual objects corresponding to the Informative Augmented Reality scene; and
upgrading the Informative Augmented Reality scene based on the customization of at least one of: the three-dimensional model and the contextual information.

2. The method of claim 1, wherein the Informative Augmented Reality scene is created by performing one of:
adding an existing three-dimensional model and the one or more contextual objects corresponding thereto, to an existing Augmented Reality scene; and
generating a three-dimensional model corresponding to the at least one object to generate an Augmented Reality scene therefrom, and wherein the one or more contextual objects are added to the generated Augmented Reality scene to create the Informative Augmented Reality scene.

3. The method of claim 2, wherein the three-dimensional model is created by performing at least one of:
facilitating the user to generate one of: a video stream and two-dimensional pictures based on the at least one object;
performing one of: image extraction and image correction from the generated video stream and the two-dimensional pictures respectively; and
performing two-dimensional to three-dimensional stitching to generate the three-dimensional model.

4. The method of claim 2 further comprising facilitating the user to customize at least one of: the existing three-dimensional model and the contextual objects corresponding thereto.

5. The method of claim 2 further comprising determining presence of at least one of: the existing Augmented Reality scene and the existing three-dimensional model.

6. The method of claim 1 further comprising determining the one or more contextual objects based on at least one of: the at least one object, the three-dimensional model, the user preferences, user situation and past history.

7. The method of claim 1 further comprising performing one or more functionalities corresponding to the upgraded Informative Augmented Reality scene, the one or more functionalities comprising:
outputting the upgraded Informative Augmented Reality scene to the user;
enabling commercialization of at least one of: the upgraded Informative Augmented Reality scene, three-dimensional model corresponding to the Informative Augmented Reality scene, and contextual objects corresponding to the Informative Augmented Reality scene; and
performing 3D printing of at least one of: the three-dimensional model, contextual objects, and Informative Augmented Reality scene.

8. The method of claim 1 further comprising determining the at least one object by performing one of:
scanning of an object based on at least one of: the user's preferences, the user's situation and the user's input.
receiving the at least one object as input from the user.

9. A computer implemented method, performed by one or more processing components, for generating three dimensional representation, the method comprising:
determining presence of at least one of three-dimensional model and at least one Augmented Reality scene corresponding to at least one object;
providing at least one of: three-dimensional model and Augmented reality scene with corresponding one or more contextual objects to a user, when the presence of at least one of three-dimensional model and at least one Augmented Reality scene is determined;
facilitating the user to perform customization of at least one of: the three-dimensional model, and the contextual objects; and
performing at least one of one or more functionalities to generate an upgraded Augmented Reality scene based on the customization.

10. The method of claim 9, wherein the one or more functionalities comprise:
embedding the customized three-dimensional model and contextual objects to the Augmented Reality scene when the presence of the Augmented reality scene is determined; and
creating an Augmented Reality scene by utilizing the customized at least one of: the three dimensional model and the contextual objects, when the presence of the Augmented reality scene is undetermined.

11. The method of claim 9 further comprising generating a three-dimensional model corresponding to the at least one object to generate an Augmented Reality scene therefrom, and wherein the one or more contextual objects are added to the generated Augmented Reality scene to create the upgraded Augmented Reality scene.

12. The method of claim 9 further comprising performing one or more tasks, the one or more tasks comprising:
outputting the upgraded Augmented Reality scene to the user;
enabling commercialization of at least one of: the upgraded Augmented Reality scene, the customized three-dimensional model, and the customized contextual objects; and
performing 3D printing of at least one of: the customized three-dimensional model, contextual objects, and the upgraded Informative Augmented Reality scene.

13. A system for generating three dimensional representation, the system comprising a processor and a memory having instructions, wherein the instructions executable by the processor to:
create an Informative Augmented Reality scene based on at least one object, the Informative Augmented Reality scene comprising:
three-dimensional model corresponding to the at least one object; and
contextual information corresponding to one or more contextual objects related to the at least one object;
facilitate the user to customize at least one of: the three-dimensional model, and information corresponding to the contextual objects corresponding to the Informative Augmented Reality scene; and
upgrade the Informative Augmented Reality scene based on the customization of at least one of: the three-dimensional model and the contextual information.

14. The system of claim 13, wherein the instructions executable by the processor creates the Informative Augmented Reality scene by performing one of:
adding an existing three-dimensional model and the one or more contextual objects corresponding thereto, to an existing Augmented Reality scene; and
generating a three-dimensional model corresponding to the at least one object to generate an Augmented Reality scene therefrom, and wherein the one or more contextual objects are added to the generated Augmented Reality scene to create the Informative Augmented Reality scene.

15. The system of claim 14, wherein the instructions executable by the processor create the three-dimensional model by performing at least one of:
facilitating the user to generate one of: a video stream and two-dimensional pictures based on the at least one object;
performing one of: image extraction and image correction from the generated video stream and the two-dimensional pictures respectively; and
performing two-dimensional to three-dimensional stitching to generate the three-dimensional model.

16. The system of claim 14, wherein the instructions, executable by the processor, further configured to facilitate the user to customize at least one of: the existing three-dimensional model and the contextual objects corresponding thereto.

17. The system of claim 14, wherein the instructions, executable by the processor, further configured to determine presence of at least one of: the existing Augmented Reality scene and the existing three-dimensional model.

18. The system of claim 13, wherein the instructions, executable by the processor, further configured to determine the one or more contextual objects based on at least one of: the at least one object, the three-dimensional model, the user preferences, user situation and past history.

19. The system of claim 13, wherein the instructions, executable by the processor, further configured to perform one or more functionalities corresponding to the upgraded Informative Augmented Reality scene, the one or more functionalities comprise:
outputting the upgraded Informative Augmented Reality scene to the user;
enabling commercialization of at least one of: the upgraded Informative Augmented Reality scene, three-dimensional model corresponding to the Informative Augmented Reality scene, and contextual objects corresponding to the Informative Augmented Reality scene; and
performing 3D printing of at least one of: the three-dimensional model, contextual objects, and Informative Augmented Reality scene.

20. The system of claim 13, wherein the instructions, executable by the processor, further configured to determine the at least one object by performing one of:
scanning of an object based on at least one of: the user's preferences, the user's situation and the user's input; and
receiving the at least one object as input from the user.
